(19) United States
(12) Patent Application Publication
(10) Pub. No.: US 2013/0188664 A1
(43) Pub. Date: Jul. 25, 2013

(54) ULTRA-BROADBAND GRAPHENE-BASED SATURABLE ABSORBER MIRROR

(71) Applicant: Shanghai Jiao Tong University, Shanghai (CN)

(72) Inventors: Guoqiang XIE, Shanghai (CN); Jie MA, Shanghai (CN); Wenlan GAO, Shanghai (CN); Liejia QIAN, Shanghai (CN); Peng LV, Shanghai (IT)

(73) Assignee: Shanghai Jiao Tong University, Shanghai (CN)

(21) Appl. No.: 13/654,334

(22) Filed: Oct. 17, 2012

(30) Foreign Application Priority Data
Jan. 20, 2012 (CN) 201210018529.7

(51) Int. Cl. H01S 3/08; G02B 5/08

(52) U.S. Cl. 372/107; 359/884

(57) ABSTRACT

An Ultra-broadband graphene-based saturable absorber mirror (graphene SAM) used as passive mode locker and Q-switch of lasers was invented. The graphene SAM comprises an optical substrate, an Aurum(Au) reflection film and graphene layer(s). Combining the ultra-broadband high reflectivity of Au film with ultra-broadband saturable absorption of graphene, the graphene SAM could be used as saturable absorber for passive mode locking and Q-switching over an ultra-wide spectral range from near-infrared to mid-infrared spectral region. Compared to semiconductor saturable absorber mirror (SESAM), the graphene SAM has the advantages of ultra-broadband operation, low linear loss, easy fabrication, low cost, and enabling mass production. This invented graphene SAM will have a wide prospect of application.

### CROSS REFERENCE TO RELATED APPLICATION

This application claims priority to Chinese Patent Application No. 201210018529.7 filed Jan. 20, 2012, which is hereby incorporated by reference herein in its entirety.

### FIELD OF THE INVENTION

This invention relates to the field of solid-state laser technology and, more particularly, to an ultra-broadband graphene-based saturable absorber mirror which could be used in Q-switched and mode-locked solid-state lasers for the generation of short and ultrashort laser pulses.

### BACKGROUND OF THE INVENTION

Solid-state lasers are the main choice for generation of high-energy, ultrashort optical pulse due to its large mode volume, and existing broadband gain media. In general, Q-switched lasers could generate nanosecond optical pulses, while mode locked lasers generate picosecond to femtosecond pulses. For Q-switching and mode-locking, a saturable absorber generally necessitate in the cavity to enable pulsing against CW operation.

Semiconductor saturable absorber mirrors (SESAMs) is a main saturable absorber for Q-switching and mode locking at present. SESAM comprises of Bragg reflection mirror and semiconductor quantum wells. SESAM fabrication process is already well mature. However, so far, almost all of the commercial SESAMs work on the near-infrared spectral region and they generally have narrow operation bandwidth (˜tens of nm) and require very complex fabrication processes. Especially, SESAMs were wavelength-dependent and require very complex bandgap engineering to meet with the operation wavelength, which limit their application.

Recently, Carbon nanotube (CNT) as a saturable absorber was experimentally demonstrated at near-infrared spectral region. The bandgap of CNT is determined by its chirality and tube diameter. However, CNTs usually cause large linear loss due to scattering of tubes. In addition, operation bandwidth is generally narrow for single type of CNTs.

Graphene is a single-atom thin sheet of carbon atoms with a honeycomb lattice, has attracted much attention due to its unique electronic and photonic properties. The Pauli blocking of electron states make it possible for graphene to be used as a saturable absorber material for passive mode locking and Q-switching. Moreover, graphene has advantages of ultrafast recovery time, lower saturation energy fluence and easy fabrication. Graphene has a zero band gap and a linear dispersion relation. Theoretically, it could be used as saturable absorber over an ultrawide spectral range from visible to mid-infrared.

### SUMMARY OF THE INVENTION

According to this invention, an ultra-broadband graphene-based saturable absorber mirror (graphene SAM) was demonstrated. To fabricate the graphene SAM, an Au reflection film was first coated on an optical substrate, then the graphene was transferred onto the Au film. Combining the ultra-broadband high reflectivity of Au film with ultra-broadband saturable absorption of graphene, the graphene SAM could be operated in an ultrawide spectral range from near infrared to mid-infrared waveband.

The general architecture of the graphene SAM comprises an optical substrate, an Au reflection film coated on the optical substrate and the graphene layer(s) on the Au film.

To put it more precisely, the optical substrate used in this invention could be made of glasses, quartz, fused silica, or SiC.

To put it more precisely, the graphene used in this invention is produced by chemical vapor deposition (CVD) process.

To put it more precisely, the graphene layer(s) used in this invention could be a single layer or multiple layers.

The advantages of the invention over the SESAM(s) are the following:
(1). The invented graphene SAM combined the broadband characteristics of Au reflection film and graphene, and has an ultra-broadband saturable absorption, which benefits to generation of few-cycle mode locked pulses, broadband wavelength-tuning of mode locked laser, laser mode locking of different waveband, generation of multiple wavelength mode locked pulses in a laser, etc.
(2). Up to now, the commercial SESAMs generally cover the near-infrared spectral range and there is no reliable mid-infrared saturable absorber yet. And for the specific SESAM, it only has a narrow operation bandwidth (˜tens of nm). The invented graphene SAM could be used as saturable absorber over an ultrawide spectral range from near-infrared to mid-infrared.
(3). The modulation depth of the graphene SAM could be adjusted by simply choosing the number of layers of graphene, which make the grapheme SAM suitable for different mode locked lasers.
(4). Aurum has a high thermal conductivity, thus the Au film on the graphene SAM benefits to dissipate heat, which is a significant advantage for high-power mode locked lasers.
(5). Compared to SESAM(s), the invented graphene SAM is easy fabrication, low cost and enabling mass production, which benefits to wide potential applications.

### BRIEF DESCRIPTION OF THE DRAWINGS

FIG. 1 shows the structure diagram of the graphene SAM.

FIG. 2 shows a way to place graphene on Au film.

FIG. 3 is the Raman spectrum of graphene 4 excited by a 514.5 nm laser source. The Raman signal of Au-coated film substrate was subtracted.

FIG. 4 is the Raman spectrum of graphene 5 excited by a 514.5 nm laser source. The Raman signal of Au-coated film substrate was subtracted.

FIG. 5 is the Raman spectrum of graphene excited by a 514.5 nm laser source in stacked region 6. The Raman signal of Au-coated film substrate was subtracted.

FIG. 6 is the experimental setup of the mode-locked laser based on graphene SAM.

FIG. 7 is the CW mode-locked pulse trains in nanosecond and millisecond time scales.

FIG. 8 is the optical spectrum of the CW mode-locked pulses.

FIG. 9 is the autocorrelation trace of the CW mode-locked pulses.

### DESCRIPTION OF THE EMBODIMENTS

FIG. 1 is the structure diagram of the graphene SAM. As shown in FIG. 1, the graphene SAM consists of optical substrate 1, Au reflection film 2 which is coated on the substrate 1 and graphene layer(s) 3. The optical substrate 1 can be glass, quartz, fused silica, or SiC and is optically polished. The Au reflection film 2 is coated onto the optical substrate 1 to realize the high optical reflectivity from near-infrared to mid-infrared spectral region. The graphene 3 was then transferred onto the Au film 2. Combining with the ultra-broadband high reflectivity of Au film 2 and ultra-broadband saturable absorption of graphene 3, the fabricated graphene SAM could be used as saturable absorber from near infrared to mid-infrared waveband.

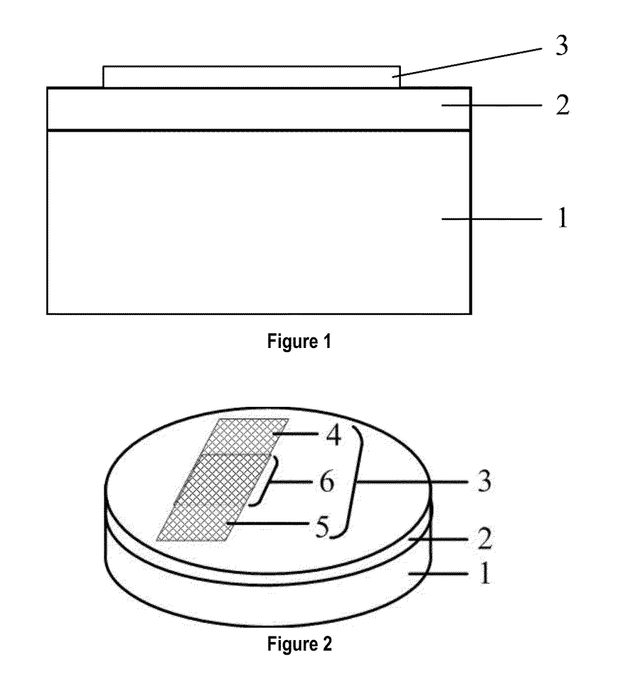

FIG. 2 shows a way to place the graphene 3 on Au film 2. A piece of graphene 4 was first put on the Au film 2. Another piece of graphene 5 was then stacked partly on the graphene 4, as shown in FIG. 2. Various modulation depths could be realized in one graphene SAM due to different graphene layers in different regions. Moreover, the layer numbers of graphene and stacking ways could be chosen according to different requirements, which was convenient for using.

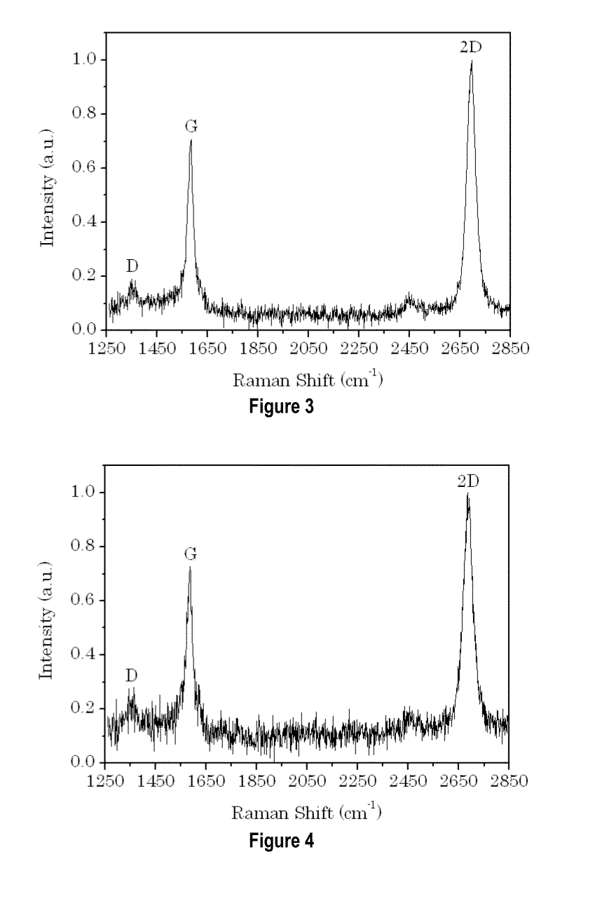

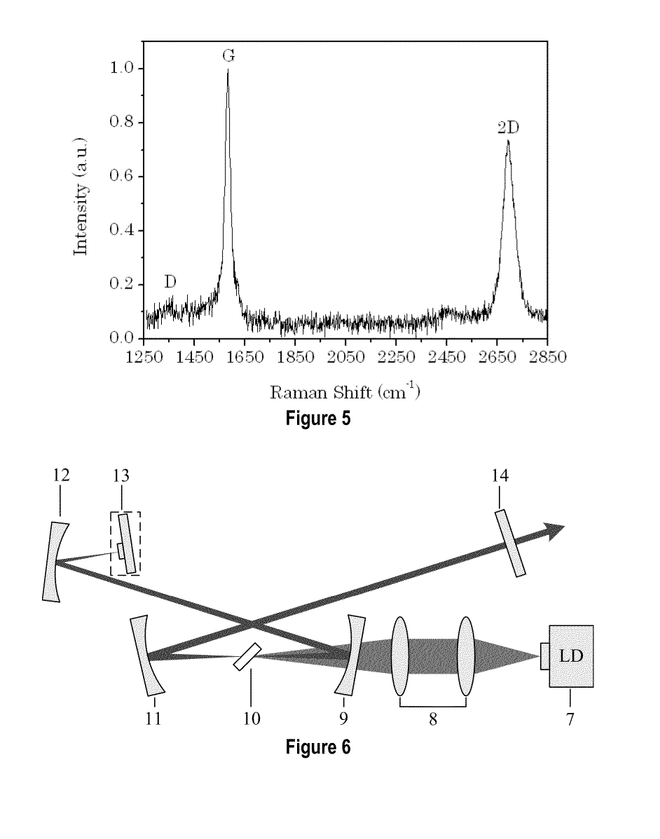

FIGS. 3-5 are Raman spectra of graphene excited by a 514.5 nm laser source in different regions. The Raman signal of Au-coated film substrate was subtracted.

When light is incident onto the graphene SAM, the graphene SAM absorb light and then the carriers in graphene transit from valence band to conduction band. Under low incident light intensity, the main effect is the linear optical absorption. At high light intensity, saturable absorption or absorption bleaching is achieved due to Pauli blocking process. To protect graphene from oxidization, inert gases could be used to blow graphene SAM in the experiment.

### EXAMPLE

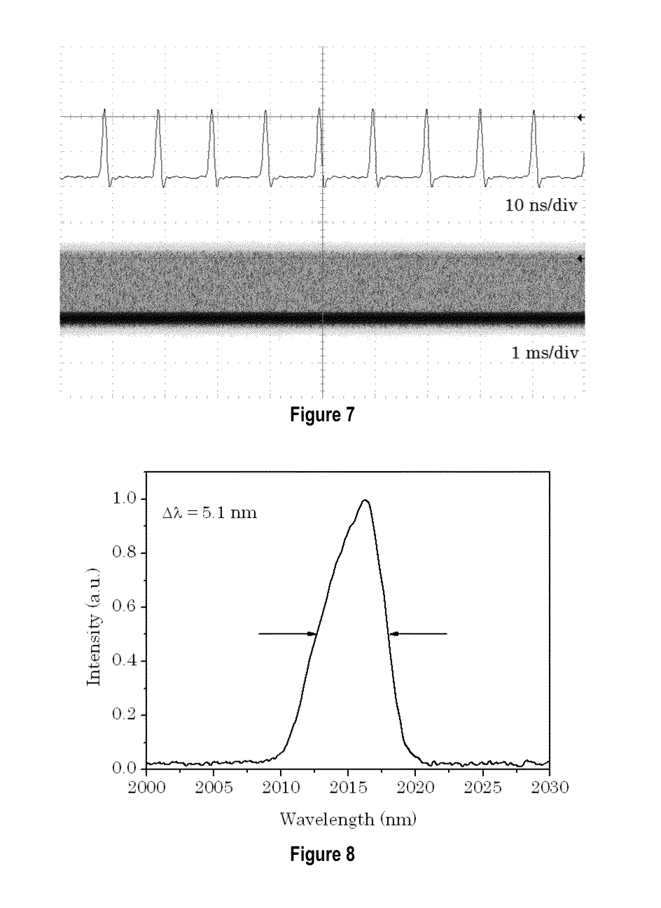

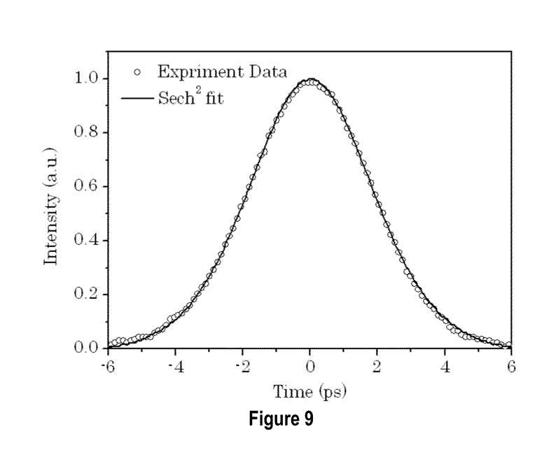

The schematic of the mode locked laser setup based on graphene SAM is shown in FIG. 6. A Brewster-cut, 8 mm-length Tm-doped laser crystal (10) is used as gain medium. The pump source (7) is a commercial laser diode. The pump light is focused into the laser crystal by two coupling convex lenses (8). In the experiment, a standard X-folded cavity is used for achieving suitable laser mode size in the crystal (10) and on the graphene SAM (13). By optimizing the position of the graphene SAM (13) and adjusting the laser cavity carefully, stable CW mode locking could be obtained. FIG. 7 shows the typical CW mode-locked pulse trains in nanosecond and millisecond time scales. No Q-switched mode locking is found from nanosecond time scale to millisecond time scale in the experiment. The mode locked pulses duration is measured by a commercial autocorrelator (APE, PulseCheck 50). The optical spectrum and autocorrelation trace are shown in FIG. 8-9. The autocorrelation trace gives the pulse duration of 2.8 ps (FWHM), assuming a sech²-shaped pulse. The spectrum of the laser is centered at 2016 nm with a FWHM bandwidth of 5.1 nm, which is measured by a mid-infrared optical spectrum analyzer with a resolution of 0.22 nm. The experimental results suggest that the graphene SAM is an excellent saturable absorber for mode locking of solid state lasers.

We claim:

1. An ultra-broadband graphene-based saturable absorber mirror (graphene SAM), comprising from bottom to up:
an optical substrate (1);
a reflection film (2) coated on the optical substrate (1); and
a graphene layer (3) on the reflection film (2).

2. The ultra-broadband graphene-based saturable absorber mirror according to claim 1, wherein said optical substrate (1) is selected from the group consisting of glasses, quartz, fused silica, SiC and a combination thereof.

3. The ultra-broadband graphene-based saturable absorber mirror according to claim 1, wherein the reflection film (2) is selected from the group consisting of an Au reflection film, an Ag reflection film, an Al reflection film, and a combination thereof.

4. The ultra-broadband graphene-based saturable absorber mirror according to claim 3, wherein said reflection film (2) is an Au reflection film.

5. The ultra-broadband graphene-based saturable absorber mirror according to claim 1, wherein said graphene layer (3) is grown by a chemical vapor deposition (CVD) process.

6. The ultra-broadband graphene-based saturable absorber mirror according to claim 1, wherein said graphene of graphene layer (3) comprises a monolayer of graphene or multiple layers of graphene.

7. The ultra-broadband graphene-based saturable absorber mirror according to claim 1, wherein the layer number and stacking ways of graphene layers in said graphene layer (3) is determined based on different requirements.

8. The ultra-broadband graphene-based saturable absorber mirror according to claim 7, when said graphene of graphene layer (3) comprises multiple layers of graphene, different layers of graphene have different sizes, shapes or depths.

9. The ultra-broadband graphene-based saturable absorber mirror according to claim 1, wherein an insert gas is used to prevent oxidization.

10. A graphene mode locked solid-state laser, comprising:
an X-folded or Z-folded laser cavity; and
an ultra-broadband graphene-based saturable absorber mirror as a cavity mirror, wherein the ultra-broadband graphene-based saturable absorber mirror comprises:
an optical substrate (1);
a reflection film (2) coated on the optical substrate (1); and
a graphene layer (3) on the reflection film (2).

11. The graphene mode locked solid-state laser of claim 10, further comprising:
a Tm-doped laser crystal (10) as gain medium.

12. The graphene mode locked solid-state laser of claim 10, further comprising:
a pump source (7).

13. The graphene mode locked solid-state laser of claim 12, wherein the pump source (7) comprises a commercial laser diode.
